(19) United States
(12) Patent Application Publication
(10) Pub. No.: US 2011/0070459 A1
(43) Pub. Date: Mar. 24, 2011

(54) Thermal Management System

(76) Inventor: Irwin In Kim, Milpitas, CA (US)

(21) Appl. No.: 12/562,854

(22) Filed: Sep. 18, 2009

(51) Int. Cl. B32B 15/00; B23K 31/00; B32B 37/00; B32B 3/10

(52) U.S. Cl. 428/615; 228/101; 156/60; 428/137

(57) ABSTRACT

Systems and methods for providing heat management solution. In one implementation, a heat spread or laminate is provided. The heat spreader or laminate includes a thermal expansion defining material such as Nickel-Iron alloy sheet or Molybdenum or Copper-Molybdenum alloy sheet or Copper-Tungsten alloy sheet or Copper-Graphite sheet or Graphite sheet with holes to contain high thermal conductive alloy such as Copper-Silver or Silver filler and high thermal conductive outer metal sheets such as Oxygen Free High Conductive copper. One of Oxygen Free High Conductive copper has corresponding hole patterns matched to the thermal expansion defining material sheets with holes. The thermal expansion layer with high thermal conductive filler is sandwiched between the high thermal conductive metal sheets.

### BACKGROUND

The present invention addresses development of low cost thermal management. Thermal management system is typically used to dissipate heat generated from electrical components. One example of an electrical component is ceramic packaged devices, such as power amplifiers and transistors. Such devices are used in various applications, including but not limited to, consumer electronics, telecommunication and automobile. Such devices generate heat that impedes functionality of such devices in the said applications unless heat is appropriately dissipated by the thermal management system. Conventional thermal management system consists of a layer or layers of metal sheet of different material with good thermal conductivity property bonded with various bonding materials. The rate of heat dissipation is governed by the thermoconductivity of thermal management system used. Conventional method to manage heat in electrical components is use of copper with various metals, such as tungsten or molybdenum. Copper in specified ratio by weight to metal is infused to such metals by various manufacturing methods, such as dry press and infiltration. High cost and mechanical properties are few concerns with the conventional thermal management system.

Further challenge in heat dissipation is the rate of heat generated over the size of electrical device. Over the years, die size in the electrical device that generates heat is becoming smaller and more powerful. Therefore, heat generated per area is continuously increasing, which demands new construction and materials for more efficient heat management. This also requires not only the material development, but also cost effective processes to form thermal management system.

### SUMMARY

An object of this invention is to devise a thermal management system, in this case, thermal sheet or laminates, to dissipate heat generated from various electrical components by using cost reducing material with specified number holes with specified sizes bonded by high thermal conductive bonding material sandwiched between outer high thermoconductive sheets. Meanwhile, the current invention maintains appropriate coefficient of thermal expansion (CTE) property to match the electrical components to prevent warpage or breakage.

The advantage of this invention is cost reduction from use of oxygen-free high conductive (OFHC) copper sheets and Nickel-alloy alloy or Molybdenum or Copper-Molybdenum alloy or other equivalent metal sheets with coefficient of thermal expansion closed matched to ceramic and silicon. Another advantage of this invention is maintaining CTE and increasing thermoconductivity with application of high conductive filler material by forming thermal expansion defining sheet between OFHC copper sheets. Although this middle layer metal is closed matched to ceramic and silicon in CTE, its thermoconductivity is relatively low compared to copper. This is overcome by having specified number of holes with specified sizes and filled with high thermally conductive bonding material such as copper-silver alloy.

Therefore this invention has thermal properties well matched to materials it is being applied with high thermal conductive property with reduced cost of material and easy manufacturing. Thermoconductivity of this invention is at least or better than the conventional thermal sheets used in the various devices.

### BRIEF DESCRIPTION OF DRAWINGS

FIG. 1 shows a top view of a thermal expansion defining layer sheet with holes

FIG. 1A shows a detail view of the top view of a thermal expansion defining layer sheet with holes

FIG. 2 shows layers of metal sheets comprising top oxygen-free high conductive (OFHC) copper sheet, OFHC copper sheet with holes, middle layer sheet with holes and two bottom OFHC copper sheets

FIG. 3 shows a cross-sectional view showing holes in a thermal expansion defining layer and copper layer filled with filler material and outer sheet

### DETAILED DESCRIPTION

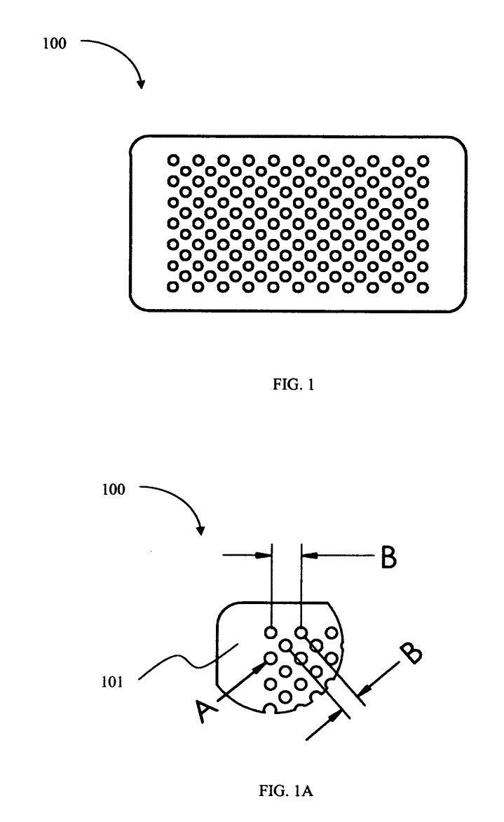

FIG. 1 shows the thermal expansion defining layer 100 with holes with various size and numbers. FIG. 1A shows detailed hole size and location 101. Total combined area of holes can vary between 20-80% of the metal layer. The table below shows how 1″×1″ metal layer can be prepared with various hole sizes and locations.

| | Holes | | | | Dimension | | | | | |
|---|---|---|---|---|---|---|---|---|---|---|
| | x1 | x2 | y | # of holes | A (in) | B (in) | C (in) | P (in) | R (in) | t (in) |
| Option 1 | 45 | 44 | 52 | 2314 | 0.015 | 0.020 | 1.000 | 0.060 | 0.025 | 0.006 |
| Option 2 | 36 | 35 | 42 | 1491 | 0.015 | 0.025 | 1.000 | 0.060 | 0.025 | 0.006 |
| Option 3 | 36 | 35 | 42 | 1491 | 0.020 | 0.025 | 1.000 | 0.060 | 0.025 | 0.006 |
| Option 4 | 30 | 29 | 35 | 1033 | 0.020 | 0.030 | 1.000 | 0.060 | 0.025 | 0.006 |
| Option 5 | 30 | 29 | 35 | 1033 | 0.025 | 0.030 | 1.000 | 0.060 | 0.025 | 0.006 |
| Option 6 | 26 | 25 | 30 | 765 | 0.025 | 0.035 | 1.000 | 0.060 | 0.025 | 0.006 |
| Option 7 | 26 | 25 | 30 | 765 | 0.030 | 0.035 | 1.000 | 0.060 | 0.025 | 0.006 |
| Option 8 | 23 | 22 | 26 | 585 | 0.030 | 0.040 | 1.000 | 0.060 | 0.025 | 0.006 |

FIG. 2 shows how thermally conductive layers and a thermal expansion defining layer are bonded together to create thermal management system 200. Outer top layer 201 and bottom layer 205 are oxygen free high conductive (OFHC) copper. Secondary top layer 202 is also OFHC copper with holes for air trap relief purpose. During brazing, copper-silver alloy used as bonding material can create air traps. Holes in secondary top layer 202 provide relief for air to escape. Any overflow of bonding material can be later polished prior to bonding outer metal layers 201 and 205. The overflow of bonding material also can be left prior to bonding outer metal layers. Secondary bottom layer 204 is also OFHC copper without holes. Middle metal layer 203 in the current invention holds the high conductive filler material which provides required thermal conductive property and maintains proper thermal expansion to match the electrical component which the thermal management system is attached to dissipate heat.

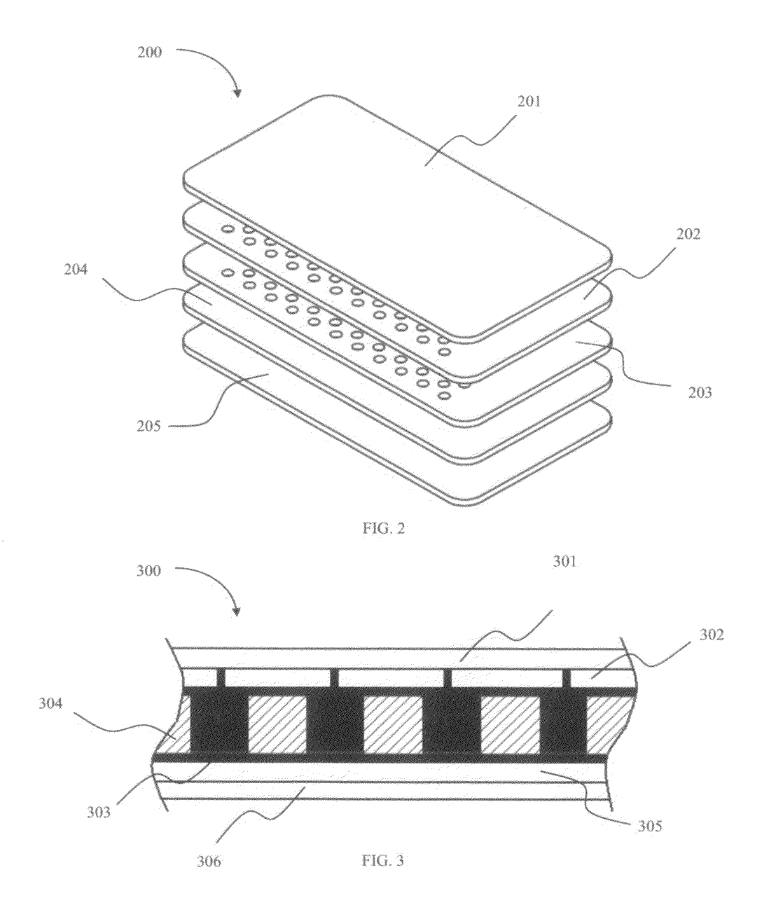

FIG. 3 shows the cross-section of thermal management system 300. First the middle metal layer 304 is placed between the secondary top layer with holes 302 and secondary bottom layer 305. Bonding material is copper-silver alloy which, at high temperature, its reflow property allows the alloy to fill the gaps in holes 303 by capillary effect. To prevent air traps during bonding process, secondary top layer 302 provide relief holes. Any overflow of bonding material can be later polished under control to keep thickness balance with layer 305. To prevent warpage during operation, outer top layer 301 and bottom layer 306 can be applied.

What is claimed is:

1. A process of forming thermal conductive sheet comprising:
a. A thermal expansion defining material, Nickel-Iron alloy sheet or Molybdenum or Copper-Molybdenum alloy sheet or Copper-Tungsten alloy sheet or Copper-Graphite sheet or Graphite sheet in various sizes and shapes, with punched or etched:
i. Holes in various sizes and
ii. Various numbers
b. An oxygen-free high conductive copper in various sizes and shapes designed to match a thermal expansion defining material (claim 1a) with punched or etched
i. Holes in various sizes and
ii. Various numbers

2. A process of bonding a Nickel-Iron alloy sheet or Molybdenum or Copper-Molybdenum alloy sheet with holes (claim 1a) between oxygen-free high conductive copper and oxygen-free high conductive copper with holes (claim 1b) with Copper-Silver alloy filler, comprising:
a. An oxygen-free high conductive copper sheet with holes (claim 1b)
b. A thermal expansion defining layer, Nickel-Iron alloy sheet or Molybdenum or Copper-Molybdenum alloy sheet or Copper-Tungsten alloy sheet or Copper-Graphite sheet or Graphite sheet with holes (claim 1a)
c. An oxygen-free high conductive copper sheet without holes
d. Optional second oxygen-free high conductive copper without holes

3. A combination of high thermoconductive filler material such as copper-silver alloy or silver alloy and thermal expansion defining material between high thermoconductive metals such as OFHC copper

4. Applying thermal expansion defining material with holes (claim 1a) as medium to hold high thermoconductive filler between high thermoconductive metals
